(19) United States
(12) Patent Application Publication
(10) Pub. No.: US 2008/0235147 A1
(43) Pub. Date: Sep. 25, 2008

(54) SYSTEM AND METHOD FOR FACILITATION OF SHIPPING FROM MULTIPLE MERCHANDISE VENDORS

(76) Inventor: Jarl Jensen, Nyack, NY (US)

Correspondence Address: SHERIDAN ROSS PC, 1560 BROADWAY, SUITE 1200, DENVER, CO, 80202, US

(21) Appl. No.: 12/049,181

(22) Filed: Mar. 14, 2008

Related U.S. Application Data
(60) Provisional application No. 60/895,686, filed on Mar. 19, 2007.

(51) Int. Cl. G06Q 30/00; G06F 17/00

(52) U.S. Cl. 705/80; 705/37; 705/26

(57) ABSTRACT

The invention relates to an improved system and method for providing a service that coordinates shipping from a plurality of merchandise vendors by combining the shipping requirements from a plurality of physical locations into one transaction. The present invention coordinates shipping from a plurality of merchandise vendors in order to streamline shipping, allowing shippers to make fewer trips by combining deliveries, thus reducing costs. In addition, this invention enables separating the cost of shipping from the cost of the product, allowing the consumer to be concerned solely with the product quality and price.

### CROSS REFERENCE TO RELATED APPLICATIONS

The present application claims the benefit of U.S. Provisional Application No. 60/895,686 filed Mar. 19, 2007, the entire contents of which are hereby incorporated herein by reference.

### FIELD

The present invention relates to electronic commerce systems and methods, and more particularly, systems and methods for coordinating shipping services to optimize shipping efficiency and lower costs.

### BACKGROUND

Internet retailing has grown into a force to challenge local retailers and businesses. A major factor keeping Internet retailing from further expanding, however, is the cost of shipping goods from the merchandise vendors to the consumer. Every Internet purchase made requires its own shipment unless it is from the same merchandise vendor. Methods for comparing prices on the Internet and Internet auction systems are well known. These methods do not address the problem of high shipping costs.

An improved system and method is needed to coordinate shipping from multiple merchandise vendors in order to streamline shipping, allowing shipping vendors to make fewer trips by combining deliveries, thus reducing costs. In addition, an improved system and method would separate the cost of shipping from the cost of the product, allowing the consumer to be concerned solely with the product quality and price.

### SUMMARY

The present invention is directed to a new and improved system and method for facilitating and coordinating merchandise shipments from multiple merchandise vendors to an individual consumer that allows the shipments to be combined into one billing event. Embodiments of the present invention include a system and method for coordination of shipping from multiple merchandise vendors where the combined shipment may be auctioned to shipping vendors for the best price and service. In accordance with further embodiments of the present invention, a system and method for coordination of shipping from multiple merchandise vendors where the customer chooses the service by clicking on an icon on the merchandise vendor's website that places the shipment into a queue along with the customer's other shipments is provided. In accordance with further embodiments of the present invention, a system and method for coordination of shipping from multiple merchandise vendors where the customer chooses to auction the shipment of only one purchase is provided.

In addition to providing benefits to a customer, the present invention offers efficiency advantages to merchandise vendors. In particular, the present invention allows shipping vendors to build algorithms to calculate their cost for fulfilling the shipping orders. In accordance with further embodiments of the present invention, a system and method for coordination of shipping from multiple merchandise vendors that tracks the shipping information of multiple merchandise vendors to individual consumers is provided.

The preset invention may be implemented in a variety of networking environments. In particular, the present invention may be implemented in a client-server network including a central server that facilitates the shipping agreements between customers and merchandise vendors. Alternatively, the present invention may be implemented in a peer-to-peer network, which does not include a central server. In a peer-to-peer environment, shipping data and transactions are routed through various network peers running on customer and vendor computers. These and other features of embodiments of the invention can be further understood from the following description, particularly when considered in connection with the accompanying drawings.

### BRIEF DESCRIPTION OF THE DRAWINGS

FIG. 1 is a diagram depicting merchandise shipments delivered as known in the prior art;

FIG. 2 is a diagram depicting merchandise shipments delivered in accordance with embodiments of the present invention;

FIG. 3 is a diagram depicting the relationship between elements associated with the present invention;

FIG. 4 is a block diagram showing a client-server network implementation of the present invention;

FIG. 5 is a block diagram of a shipping auction server in accordance with embodiments of the present invention;

FIG. 6 is a block diagram of a peer-to-peer network implementation of the present invention;

FIG. 7 is an illustration of an exemplary graphical user interface in accordance with embodiments of the present invention; and

FIG. 8 is a flow chart illustrating aspects of a method in accordance with embodiments of the present invention.

### DETAILED DESCRIPTION

The present invention is directed to a system and method for facilitating the shipment of one or more items from merchandise vendors to a customer. The present invention allows a customer to purchase a number of items over the Internet and to place the shipping of the items up for auction or competitive bidding. The invention will facilitate lowering the cost of shipping for Internet purchases in order to compete with the over all cost of shopping from local retailers. Using previous methods, every Internet purchase made requires its own shipment unless it is from the same merchandise vendor. In contrast, the present invention allows the customer to combine shipping orders for merchandise purchased from multiple e-commerce merchandise vendors and then review and/or auction those shipping orders for the best price and service. In addition, the present invention allows for an increase in the available options for shipping regardless of the particular merchandise vendor or number of merchandise vendors used.

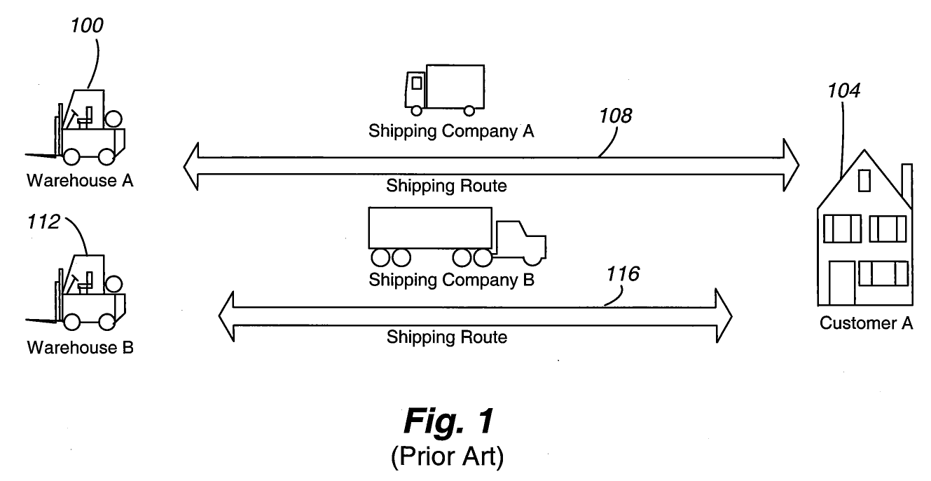

FIG. 1 shows the relationship between customers and shipping vendors as it exists in the prior art. This relationship consists of one delivery for each purchase made. In particular, a customer who has made a purchase from a particular vendor will have the merchandise delivered from the merchandise vendor's warehouse 100 to the customer's location 104 in a first shipment 108. The same customer may also make a purchase from a second merchandise vendor. The purchased merchandise will be delivered from the second merchandise vendor's warehouse 112 to the customer's location 104 in a second shipment 116. For a customer who wishes to make multiple on-line purchases this arrangement is not cost-effective. In particular, the shipping costs that must be made with each purchase may make on-line shopping prohibitively expensive in comparison to shopping at local retailers near the customer's location.

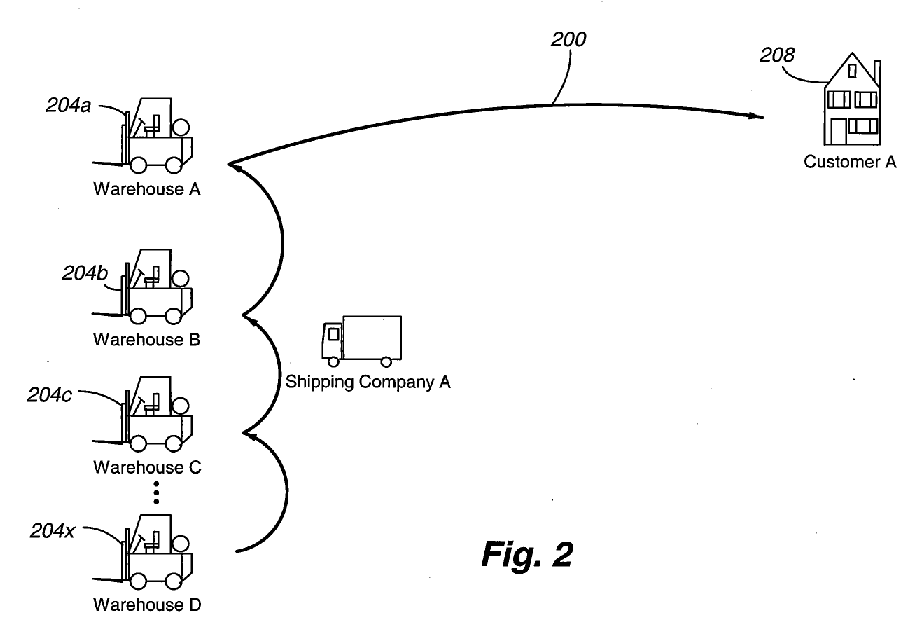

FIG. 2 shows the relationship between customers and shipping vendors, as it would exist with the implementation of the present invention. In particular, a customer makes a number of purchases from a number of different merchandise vendors and uses the present invention to combine the shipping of all merchandise into one transaction. More particularly, the present invention facilitates a single shipment 200 from the various warehouses 204a-x, which are associated with different vendors, to the customer location 208. Accordingly, merchandise purchased from a number of merchandise vendors may be delivered together. As a result the reduced shipping costs make on-line shopping more cost effective.

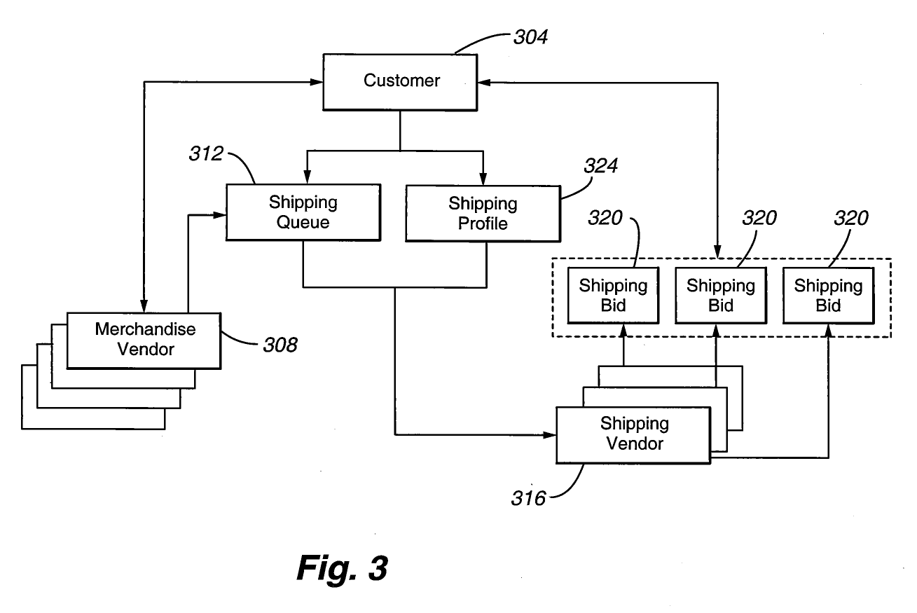

Initially, a general description of the present invention will be given with reference to FIG. 3, which illustrates the basic elements associated with the present invention. The present invention is directed to facilitating the shipment of one or more items obtained by a customer 304 through one or more on-line transactions. Specifically, the customer 304 purchases a number of items through one of more online merchandise vendors 308. The shipping orders for the purchased items are recorded in a shipping queue 312, which is posted for a number of shipping vendors 316 to consider. Each shipping vendor 316 then may post a shipping bid 320 for consideration by the customer 304. A winning shipping bid is then chosen from the posted shipping bids 320.

In order to be able to consider and/or process the shipping order contained in the shipping queue 312, the shipping vendors 316 may need to have the customer's 308 name and address. In that regard, the customer 304 may establish a shipping profile 324 that includes, at a minimum, the customer's 308 name and address. The shipping profile 324 may be posted along with the shipping queue 308 or may be otherwise accessed by the shipping vendors 316 during the bidding process.

The shipping bids 320 may be updated dynamically as the customer 304 continues to shop. In particular, with each on-line purchase a new shipping order may be added to the shipping queue 312. An updated shipping queue 312 may then be posted for consideration by the shipping vendors 316. Based on each new shipping queue 312 the shipping vendors 316 may then post updated shipping bids 320. The customer 304 may also modify the shipping queue 312 by, for example, by removing particular items. New shipping bids 320 may then be posted based on the modified queue 312.

The wining shipping bid may be chosen from the posted shipping bids 320 using any one of a number of different methods. In accordance with embodiments of the present invention, customer 304 may receive and review all of the posted shipping bids 320. The customer 304 may then select a winning shipping bid based on considerations such as price and/or shipping time. In accordance with alternative embodiments of the present invention, the winning shipping bid may be generated based on a predetermined set of customer preferences. In particular, the customer 304 may include in the shipping profile 324 parameters such as price ranges and/or minimum shipping times that allow the winning shipping bid to be generated automatically. Additionally, the winning shipping bid may be selected by a combination of these two methods. In particular, the posted shipping bids 320 may be filtered based on a predetermined set of customer 304 preferences to produce a subset of shipping bids 320 that is then presented to the customer 304 for consideration.

The winning shipping bid may be chosen based on a negotiation between the customer 304 and a particular shipping vendor 316. In particular, a customer 304 may accept a shipping bid 320 provided particular contingencies are met. If the shipping vendor 316 agrees to the contingencies the transaction can go forward.

As can be appreciated by one of skill in the art from the disclosure herein, a number of factors will be considered by the shipping vendors 316 in determining a shipping bid 320 for a particular shipping queue 312. For example, the location of the various warehouses that contain the merchandise, the customer's location, the cost of picking-up the merchandise, the number of units being shipped et cetera. Shipping vendors 316 may use or provide algorithms to automatically generate shipping bids 320. A sample algorithm for calculating shipping costs is as follows:
X=The cost of delivering one shipment to a customer
Y=The cost of picking up one product from a manufacturer or distribution center
Z=The number of units being shipped from the manufacturer
P=The number of products being delivered to a customer
OH=Over Head of the shipping vendor including routine travel routes
TS=Total shipments made by shipping vendor

Total cost of shipment=X/P+Y/Z+OH/TS

Since Z, P and TS decrease the average cost of shipping as the number of products increases it is clear that this is a scalable scenario. In other words, both the shipping vendor 316 and the customer 304 will wind up winning by combining shipping requirements from multiple sellers or merchandise vendors 308.

In determining shipping bids 320, the shipping vendors 316 also may have access to the shipping profiles 324 established by particular customers 304. A database containing the shipping profiles 324 for particular customers 304 accessible to the shipping vendors 316 may be provided in an industry standard format to facilitate use by multiple shipping vendors 316. Additionally, the shipping queue 312 itself may contain information needed by the shipping vendors 316 in their consideration of the shipping queue 312. In particular, the shipping queue 312 may include product descriptions and a number of ship-from addresses associated the merchandise vendors 308. Additionally, the shipping vendors 316 may directly contact the merchandise vendors 308 to obtain information such as, for example, a ship-from address or product descriptions such as size and weight

In accordance with embodiments of the present invention, the shipping vendors 316 may develop their own algorithms to calculate the cost of shipping merchandise from the merchandise vendors 308 to the customer 304. The more accurate these algorithms are the more profitable the shipping vendors 316 will be. The shipping vendors 316 will only bid on shipping queues 312 that will meet profit requirements. When the cost algorithm is wrong it is very likely that less profitable work will be won. As mentioned previously, the linear logistic product flow shown in FIG. 1 is not advantageous for the customer 304. Additionally, this type of product flow can contain disadvantages for shipping vendors 316. In particular, ship-from locations, shipping vendors, shipping routes, and ship-to locations are not coordinated or consolidated. The non-linear logistic product flow shown in FIG. 2, which is achieved with the implementation of embodiments of the present invention, provides a shipping vendor 316 with a total picture of marketplace shipping requirements (shipping requirements from multiple customers) and allows for an optimization of efficiencies with a reduction of shipping costs. With marketplace shipping requirements known, the present invention can provide a given shipping vendor 312 with multiple ship-from locations and multiple ship-to locations. Shipping routes can be consolidated and coordinated to optimize resources and reduce shipping costs. It should be appreciated that it is not necessary for shipping vendors 316 to develop algorithms for calculating shipping costs. In particular, a given shipping vendor 316 may wish to inspect the posted shipping queues 312 and generate shipping bids 320 on a case-by-case consideration of the contents of shipping queue 312.

Embodiments of the present invention may be implemented as a service that maintains customer 304 and/or shipping vendor 316 information and facilitates shipping agreements negotiated between customers 304 and shipping vendors 316. In particular, an auction service in accordance with embodiments of the present invention allows the customer 304 to combine shipping orders from multiple merchandise vendors and then auction those shipping orders for the best price and service. For example, the customer 304 can select this auction service by clicking on a particular icon on the merchandise vendor's 308 web page. This action can also allow for the placement of the customer's 304 information in a database. The shipping options for the items in the queue 312 can then be obtained. Optionally, the customer 304 can be asked for personal information or to join the service for faster future service. The customer 304 then has the option of selecting a shipping vendor 316 based on the shipping options presented, and initiating shipment of the products or to continue shopping. The auction service may maintain a list or database of delivery addresses indexed by customer name.

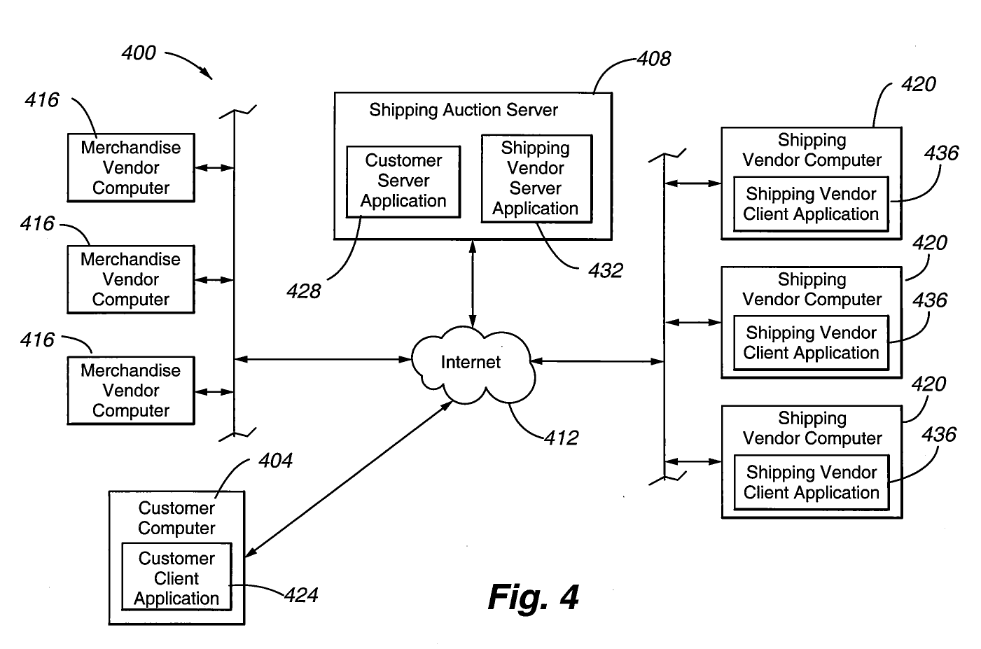

FIG. 4 illustrates components of a system 400 that implements an auction service in accordance with embodiments of the present invention. The system 400 is implemented as client-server network. Accordingly, the system 400 includes a client or customer computer 404 in communication with an auction server 408. The auction server 408 may comprise a general-purpose computer capable of executing application programming for use in connection with an auction service. The customer computer 404 and the auction server 408 communicate with each other over a data network, such as the Internet 412. Additionally, the system 400 shown in FIG. 4 includes a number of merchandise vendor computers 416 and a number of shipping vendor computers 420. The merchandise vendor servers 416 may host e-commerce websites or otherwise facilitate the online purchase of merchandise sold by merchandise vendors 308. The shipping vendor computers 420 may host e-commerce websites or otherwise facilitate the online purchase of shipping contracts or agreements offered by the shipping vendors 316.

In general, an auction service in accordance with embodiments of the present invention may include at least a customer module and a number of shipping vendor modules. In the client-server system 400 shown in FIG. 4, the customer module includes a customer client application 424 running on the customer computer 404 and a customer server application 428 running on the auction site sever 408. The shipping vendor modules include a shipping vendor server application 432 running on the auction server 408 and plurality of shipping vendor client applications 436 running on the shipping vendor computers 420.

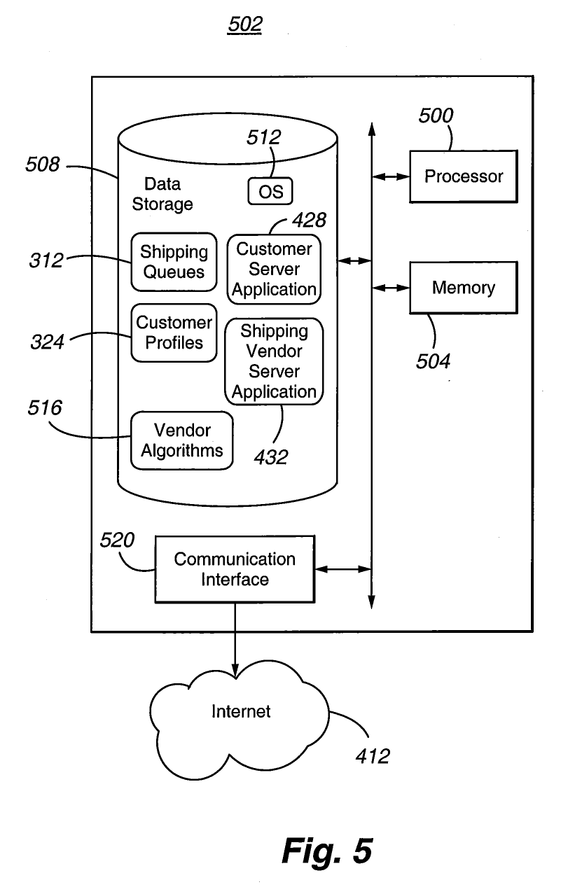

FIG. 5 illustrates the components of a computer 502, such as may be used in connection with implementing a customer computer 404, an auction server 408, or a shipping vendor computer 420. The computer 502 may include a processor 500 capable of executing program instructions. Accordingly, the processor 500 may include any general-purpose programmable processor or controller for executing application programming. Alternatively, the processor 500 may comprise a specially configured application specific integrated circuit (ASIC). The processor 500 generally functions to run programming code implementing various functions performed by the auction server 408 or other system component being implemented. For example, such functions may include functions enabled through the execution of programming code or other application instructions.

The computer 502 may additionally include memory 504 for use in connection with the execution of programming by the processor 500, and for the temporary or long-term storage of data or program instructions. For example, the memory may be used in connection with the operation of applications. The memory 504 may comprise solid-state memory resident, removable or remote in nature, such as DRAM and SDRAM. Data storage 508 may be provided for the storage of application programming and/or data. For example, operating system software 512 may be stored in the data storage 508. Examples of particular applications that may be stored in data storage 508 are the customer server application 428 and the shipping vendor server application 432. The data storage 508 may be operable to store shipping queues 312, shipping profiles 324, cookies, tags, and/or other data associated with facilitating shipping agreements between the customer 304 and one or more of the shipping vendors 316. For example, in connection with a customer computer 404, a data storage 508 may include tracking software that allows an auction service to monitor a customer's online purchases and to automatically generated shipping bids 320. The tracking software may be installed and may operate based on permission given by a user. Additionally, the data storage 508 may store a number of algorithms 516 provided by the shipping vendors 316. The algorithms 516 may be used by the auction server 408 to generate shipping bids 320 for the shipping queue 312 without having to directly contact to merchandise vendor computers 420.

The computer 502 may additionally include a communication interface 520 operable to connect the auction server 408 or other component to the Internet 412. Communications over the Internet 412 may include communications between the customer server application 428 and the customer client application 424 to accomplish such tasks as registering the customer's 304 name and address, adding or deleting items to a shipping queue 312, transmitting a shipping queue 312, transmitting or updating shipping profiles 324, transmitting posted shipping bids 320, and/or receiving winning shipping bids. Additionally, the shipping vendor server application 432 may communicate over the Internet 412 with various shipping vendor client applications 436 to accomplish such tasks as posting shipping queues 312, receiving shipping bids 320, and posting winning shipping bids. Additionally, particular applications running on the auction site server 408 may communicate over the Internet 412 with various merchandise vendor computers 416 to obtain product information to be included in a particular shipping queue 320.

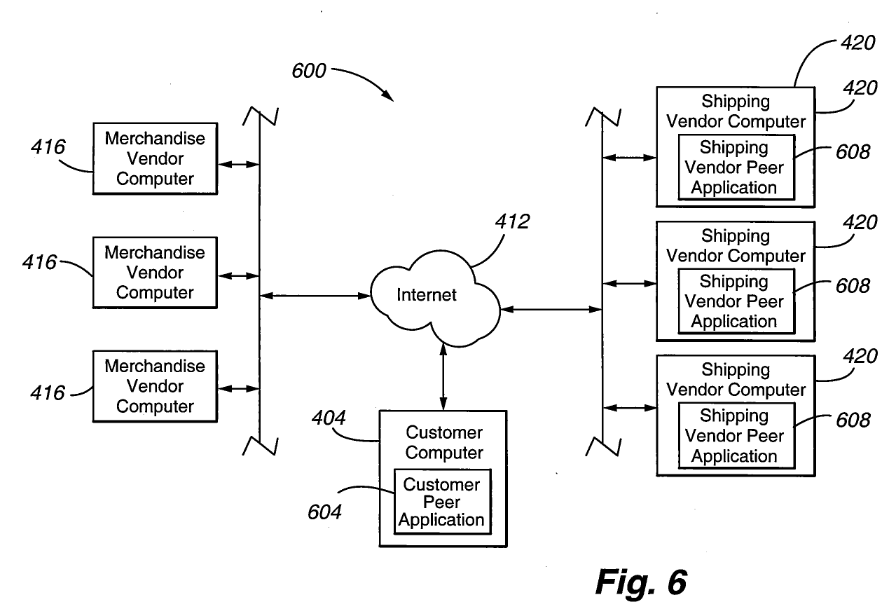

FIG. 6 illustrates an alternative embodiment of the present invention, in which the auction service may be implemented using a peer-to-peer network or system 600. The peer-to-peer system 600 implements all of the functions of an auction service without requiring the use of a central server. In particular, all of the data routing functions typically performed by a central server are distributed throughout various applications that are running on the computers used by various customers 304 and shipping vendors 320. In a peer-to-peer network 600, the customer module includes a customer peer application 604 running on the customer computer 404. The shipping vendor modules include a plurality shipping vendor peer applications 608 running on the shipping vendor computers 420.

In the peer-to-peer system 600, a particular shipping queue 312 may be maintained at the customer computer 404 while the customer 304 is shopping online. Once the customer 304 has finished shopping, a complete shipping queue 312 may be posted. Posting the shipping queue 312 may include transmitting the queue 312 through the various nodes of the peer-to-peer network to all appropriate shipping vendor computers 420. Similarly, after considering the shipping queue 312, the shipping vendors 316 may post shipping bids 320 over the peer-to-peer network for consideration by the customer 304. Additionally, the customer peer application 604 may contain information such as the shipping profile 324 which may be accessed by the shipping vendor computers 420 over the peer-to-peer network.

In a peer-to-peer network, particular nodes or network peers may be designated as “super-nodes.” Super-nodes are network peers that take on larger amounts a data routing tasks. A customer 304 or a shipping vendor 316 may elect to have their peer application designated as a super-node. As can be appreciated, super-nodes consume greater amounts of computer memory and handle greater amounts of data traffic than a typical peer application. Accordingly, discounts or rebates may be offered by the auction service to those customers 304 or shipping vendors 316 that host a super-node. Alternatively, temporary super-nodes may appear dynamically at various nodes in the network without any nodes being designated as super-nodes.

In both the client-server implementation of the auction service and the peer-to-peer implementation, shipping transaction are executed by a customer 304 using the customer computer 404. The customer computer 404 may include a processor capable of executing program instructions; memory or other data storage for use in connection with the execution of programming by the processor and for the temporary or long-term storage of data or program instructions; and a communication interface operable to connect the auction server customer computer to the Internet 412 In addition, various customer input devices and customer output devices may be provided. Examples of customer input devices include a microphone, keyboard, numeric keypad and pointing device combined with a screen or other position encoder. Examples of customer output devices include a speaker, alphanumeric display, ringer, or display.

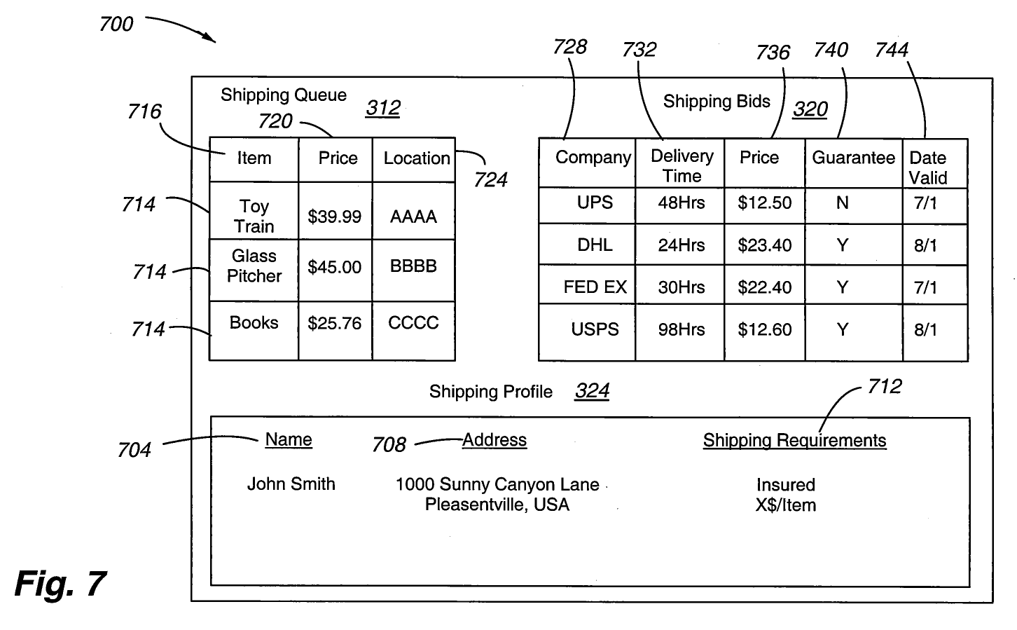

A graphical user interface is typically displayed on screen or other output device associated with the customer computer 404. The graphical user interface facilitates the e-commerce transactions associated with the present invention. FIG. 7 illustrates an exemplary graphical user interface 700 that displays auction elements such as a shipping profile 324, a shipping queue 312 and a number of shipping bids 320. As can be seen, the shipping profile 324 includes the customer name 704 and address 708. Additionally, the shipping profile 324 may include a number of shipping preferences 712. The shipping queue 312 includes a number of shipping orders 714. By way of illustration, the shipping orders 714 may include a listing of items 716 each having a price 720 and a location 724. The data associated with shipping queue 312 and the shipping profile 324 may be stored locally at the customer computer 404, at the auction site server 408 (if applicable), or at various node of a peer-to-peer network (if applicable).

The exemplary graphical user interface 700 additionally includes a plurality of shipping bids 320. The shipping bids 320 are received and displayed by the customer computer 404 after the shipping queue 312 has as been posted. The shipping bids 320 may be displayed in a preferential ordered based on one or more predetermined criteria. For example, one or more shipping bids 320 may appear in prominent positions based on past performance, bid results, and/or a fee-based relationship with the auction service. In this way, the auction service is able to provide top recommendations for shipping vendors 316. On the customer computer 404, the shipping bids 320 may be updated dynamically as items 716 are added to or removed from the shipping queue 312. By way of illustration the shipping bids 320 may include a shipping company name 728, a delivery time 732, a delivery price 736, a guarantee 740 and a date 744 after which the shipping bid is no longer valid.

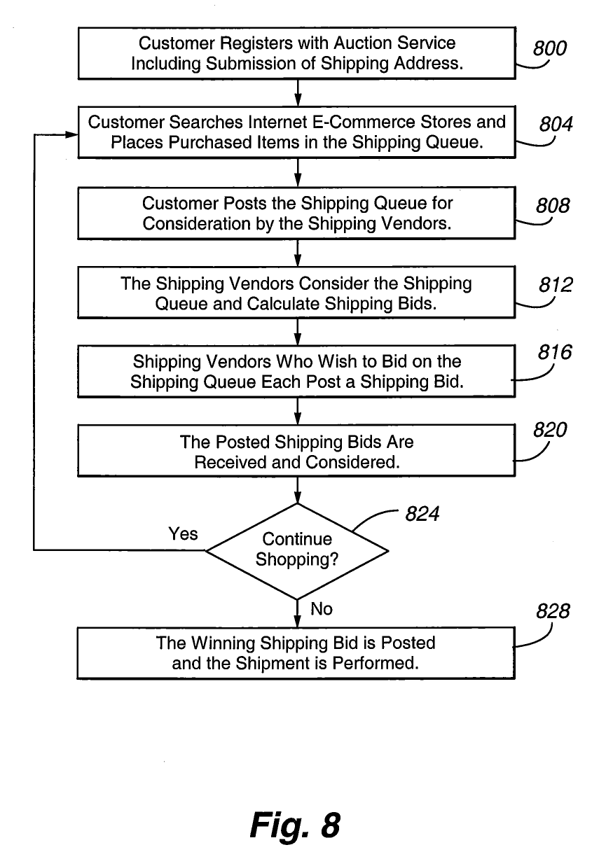

FIG. 8 is flow chart that illustrates a method of facilitating a shipment in accordance with embodiments of the present invention. Initially, at step 800 the customer 304 registers with the auction service including recording a name 704 and address 708. Optionally, this step may be done later. Specifically, the customer 304 may be prompted to register with the auction server after making an on-line purchase.

At step 804, the customer 304 searches on-line e-commerce sites for merchandise offered by various merchandise vendors 308. With each on-line transaction the customer 304 may place a shipping order 714 in the shipping queue 312.

At step 808, the shipping queue 312 is posted for consideration by the shipping vendors 316. The shipping queue 312 may be posted after the customer 304 has completed all on-line purchases. Alternatively, the shipping queue 312 may be posted after one or more orders are placed in the shipping queue 312. By posting the shipping queue 312 after each on-line purchase the customer 304 is able to track a running total of shipping costs as the customer 304 shops. In accordance with embodiments of the invention, posting the shipping queue 312 may include instructing the auction site server 408 to transmit the shipping queue 312 to the shipping vendor computers 420. Alternatively, posting the shipping queue 312 may include causing the shipping queue 312 to be routed through a peer-to-peer network to the shipping vendor computers 420.

At step 812, the shipping vendors 308 calculate shipping bids 320 based on the posted shipping queue 312. The shipping bids 320 may be calculated based on a variety of considerations including the prices 720 and location 724 of each item 716 in the queue 312. The shipping vendors may also consider information contained in customer shipping profile 324 such as the customer's 304 address and shipping requirements 712. Additionally, in considering the shipping queue 312 the shipping vendors may directly contact the merchandise vendors 308 to obtain further information about the various items 716 in the queue 312. In accordance with embodiments of the present invention, shipping bids 320 may be calculated at the auction server 408 using algorithms 516 provided by the merchandise vendors 308.

At step 816, the shipping vendors 316 who wish to bid on the shipping queue 312 each post a shipping bid 320. A posted shipping bid 320 will typically include an offer to process all shipping orders 714 in the shipping queue 312. Depending on how the auction is implemented, posting of the shipping bids 320 can take place through an auction server 408 or can include a routing of the shipping bids 320 through a peer-to-peer network.

At step 820, the posted shipping bids 320 are considered. Consideration of the posted shipping bids can entail the customer 304 reviewing all posted shipping bids 320. Alternatively, the posted shipping bids 320 may be processed by computer based on the customer's 304 predetermined shipping requirements 712. Processing the shipping bids 320 may include selecting a subset of the bids 320 for consideration by the customer 304 or automatically generating the winning shipping bid. Processing of the shipping bids 320 may take place at the auction server 408 or at particular nodes of a peer-to-peer network. In other words, if automatic processing selected, the customer 304 may not receive all the posted shipping bids 320. Additionally, in considering the shipping bids 320, the customer 304 may remove particular items 716 from the queue and receive updated shipping bids 320.

At decision diamond 824, the customer 304 may determine whether to continue shopping. All the items that are currently needed may have been purchased or the shipping costs that have accumulated may necessitate that the customer shop no more. Accordingly, if the customer does not wish to shop any longer, the method may proceed to step 828. Alternatively, if the customer wishes to continue shopping the method may return to step 804.

At step 828, a winning shipping bid selected from the plurality of posted shipping bids is posted. As mentioned above, the winning bid may be selected manually, automatically, or by a combination of these two methods. After the winning bid is received by a particular shipping vendor 316 (over a client-server or a peer-to-peer network), the particular shipping vendors 316 proceeds to process the shipping queue 312.

The foregoing discussion of the invention has been presented for purposes of illustration and description. Further, the description is not intended to limit the invention to the form disclosed herein. Consequently, variations and modifications commensurate with the above teachings within the skill or knowledge of the relevant art are within the scope of the present invention. The embodiments described herein above are further intended to explain the best mode presently known of practicing the invention and to enable others skilled in the art to utilize the invention in such or in other embodiments and with the various modifications required by the particular application or use of the invention. It is intended that the appended claims be construed to include alternative embodiments to the extent permitted by the prior art.

What is claimed is:

1. A method of facilitating a shipment, comprising:
receiving a shipping request, wherein the shipping request includes at least a shipping queue having at least one shipping order;
posting the shipping request;
receiving a plurality of shipping bids associated with a plurality of different shipping vendors, the plurality of shipping bids comprising an offer to process all shipping orders in the shipping queue;
determining a winning shipping bid; and
posting the winning shipping bid to a particular shipping vendor, the particular shipping vendor being one of the plurality of shipping vendors.

2. The method of claim 1, wherein posting the shipping request includes:
transmitting the shipping request to the plurality of shipping vendors.

3. The method of claim 1, wherein after receiving the plurality of shipping bids the method further includes
calculating a winning shipping bid based on a plurality of algorithms, wherein each algorithm is provided by a different shipping vendor and each algorithm is used to calculate at least a cost of shipping all the items in the shipping queue to the customer.

4. The method of claim 1, wherein determining the winning shipping bid includes:
selecting a subset of the plurality of shipping bids based on a predetermined set of customer preferences;
transmitting the subset of the plurality of shipping bids to the customer; and
receiving a winning shipping bid chosen by the customer.

5. The method of claim 1, wherein determining the winning shipping bid includes:
selecting a winning shipping bid based on a predetermined set of customer preferences.

6. The method of claim 1, wherein determining the winning shipping bid includes:
transmitting the plurality of shipping bids to the customer; and
receiving a winning shipping bid chosen by the customer.

7. The method of claim 6, wherein prior to determining the winning shipping bid, the method further comprises:
iteratively repeating receiving the shipping request, posting the shipping request, and receiving the plurality of shipping bids until the customer has completed a shopping session, after which the shipping queue contains at least two items from different merchandise vendors.

8. The method of claim 1, wherein at least one shipping bid includes at least one of the following shipping specifications:
a minimum delivery time;
an option to purchase insurance;
an itemized list of costs for each item in the shipping queue;
a total cost to deliver the shipment;
a name of the company that will deliver the shipment; and
a time period for which the shipping bid will remain valid.

9. The method of claim 8, wherein determining a winning shipping bid includes establishing a negotiation between the customer and at least one shipping vendor the negotiation including coming to an agreement on at least one shipping specification.

10. The method of claim 1, wherein the shipping request includes:
a description of the item;
a ship-to location associated with the customer; and
at least one ship-from location associated with the merchandise vendor.

11. The method of claim 1, wherein in response to the winning shipping bid being posted to the particular shipping vendor, the particular shipping vendor processing the at least one shipping order in the shipping queue by collecting, form at least one merchandise vendor, at least one merchandise item associated with the at least one shipping order and delivering the at least one merchandise item to a customer associated with the shipping queue.

12. A system for facilitating a shipment, comprising:
a customer module operable to receive a shipping queue from a customer, the shipping queue having at least one shipping order, the shipping queue being operable to contain a plurality of shipping orders from a plurality of different merchandise vendors and wherein the shipping module is operable to post a shipping request for the shipping queue;
at least two shipping vendor modules associated with a plurality of shipping vendors, the shipping vendor modules being operable to receive the posted shipping request, to determine a plurality of shipping bids for the shipping request, and to report the shipping bids to the customer module;
wherein a particular shipping bid from a particular shipping vendor is chosen as the winning shipping bid.

13. The system of claim 12, wherein the customer module includes a customer client application running on a customer computer and a customer server application, and wherein the at least two shipping vendor modules each include shipping vendor client applications running on shipping vendor computers and a shipping vendor server application.

14. The system of claim 12, wherein the customer module is operable to display a particular shipping bid in a prominent position based on at least one of:
(i) a past performance of a shipping vendor associated with the particular shipping bid;
(ii) content of the shipping bid; and
(iii) a fee-based relationship.

15. The system of claim 13, wherein the customer client application is operable to automatically track online purchases made by the customer and to automatically compile and post the shipping queue based on the tracked online purchases.

16. The system of claim 13, wherein the customer server application is operable to maintain a database of delivery addresses indexed by customer.

17. The system of claim 13, wherein the customer client application includes an interface for entry of the shipping queue, the customer server application being operable to receive the shipping queue form the customer client application and to post the shipping request including the shipping queue.

18. The system of claim 17, wherein the shipping vendor server application is operable to receive and process the posted shipping request, wherein processing the shipping request includes at least one of:
(i) a calculation of a winning shipping bid based on a plurality of algorithms, wherein each algorithm is provided by a different shipping vendor and each algorithm is used to calculate at least a cost of shipping all the items in the shipping queue to the customer; and
(ii) a transmission of the shipping request to the shipping vendors client applications and receipt of a plurality of shipping bids from the shipping vendors client application, the plurality of shipping bids having been posted in response to the shipping request.

19. The system of claim 18, wherein at least one of the plurality of shipping bids received from the shipping vendor client applications was generated based on a predetermined algorithm.

20. The system of claim 17, wherein the customer server application determines the winning bid by a least one of the following:
(i) a selection of a subset of the plurality of shipping bids based on a predetermined set of customer preferences, a transmission of the subset of the plurality of shipping bids to the customer client application; and receipt of a winning shipping bid from the customer client application, the winning shipping bid having been chosen by the customer.
(ii) a selection of a winning shipping bid based on a predetermined set of customer preferences; and
(iii) a transmission of the plurality of shipping bids to the customer client application; and a receipt of a winning shipping bid from the customer client application, the winning shipping bid having been chosen by the customer.

21. The system of claim 12, wherein based on the receipt of a first plurality of shipping bids from the shipping vendor module, the customer module is operable to post an updated shipping request including an updated shipping queue, the update shipping queue being based on a consideration of shipping costs made by the customer based on the first plurality of shipping bids.

22. The system of claim 12, wherein at least one shipping bid includes at least one of the following shipping be specifications:
a minimum delivery time;
an option to purchase insurance;
an itemized list of costs for each item in the shipping queue;
a total cost to deliver the shipment;
a name of the company that will deliver the shipment; and
a time period for which the shipping bid will remain valid; and
wherein the shipping request includes:
a description of the item;
a ship-to location associated with the customer; and
at least one ship-from location associated with the merchandise vendor.

23. The system of claim 12, wherein the customer module includes an application running on a customer computer and the at least two shipping vendor module include an application running a shipping vendor computers, and the customer module and the at least one shipping vendor modules are each nodes of a peer-to-peer network.

24. A system for facilitating a shipment, comprising:
means for posting a shipping request the shipping request including a shipping queue from a customer, the shipping queue having at least one shipping order, the shipping queue being operable to contain a plurality of shipping orders from a plurality of different merchandise vendors;
means for receiving a plurality of shipping bids from a plurality of shipping vendors, the plurality of shipping bids having been posted in response to the shipping request; and
means for determining a winning shipping bid, the winning shipping bid being one of the plurality of shipping bids.

25. The system of claim 24, wherein the winning shipping bid is at least one of:
chosen manually by the customer; and
chosen automatically based on a predetermined customer profile.
